(19) United States
(12) Patent Application Publication
(10) Pub. No.: US 2026/0330211 A1
(43) Pub. Date: Oct. 22, 2026

(54) SYSTEMS AND METHODS OF OPERATING THEREOF, MEMORY SYSTEMS AND METHODS OF OPERATING THEREOF, AND COMPUTER-READABLE STORAGE MEDIUMS

(71) Applicant: Yangtze Memory Technologies Holding Co., Ltd., Wuhan (CN)

(72) Inventors: Chunyuan HOU, Wuhan (CN); Yue SHENG, Wuhan (CN); Zongliang HUO, Wuhan (CN)

(21) Appl. No.: 19/415,223

(22) Filed: Dec. 10, 2025

Related U.S. Application Data
(63) Continuation of application No. PCT/CN2025/089556, filed on Apr. 17, 2025.

(51) Int. Cl. G06N 3/065; G06N 3/0499

(52) U.S. Cl. CPC G06N 3/065; G06N 3/0499

(57) ABSTRACT

The examples of the present disclosure provide a system and an operation method thereof. In an example, the system includes at least one processor, a non-volatile memory device, and a memory controller coupled to the non-volatile memory device. The at least one processor is configured to: perform a pre-filling operation of large model reasoning, and output a first key-value generated in the pre-filling operation. The memory controller is configured to: store the first key-value in the non-volatile memory device, obtain the first key-value from the non-volatile memory device to perform a decoding operation of the large model reasoning, and store the second key-value generated in the decoding operation in the non-volatile memory device.

### CROSS-REFERENCE TO RELATED APPLICATIONS

This application is a continuation of International Application No. PCT/CN 2025/089556, filed on Apr. 17, 2025, the disclosure of which is hereby incorporated by reference in its entirety.

### TECHNICAL FIELD

The present disclosure relates to the field of semiconductor technology, and relates to but is not limited to a system and a method of operating thereof, a memory system and a method of operating thereof, and a computer-readable storage medium.

### BACKGROUND

With the rapid development of data storage technology, more and more data storage systems appear in electronic devices used by people, such as solid state drives (SSD) etc. SSD have been widely used in the fields of military, automotive, industrial, medical, and aviation due to their fast read and write speeds, vibration resistance, low power consumption, no noise, low heat and light weight.

### SUMMARY

According to a first aspect of an example of the present disclosure, a system is provided, comprising a processor, a non-volatile memory device, and a memory controller coupled to the non-volatile memory device; wherein the processor is configured to: perform a pre-filling operation of large model reasoning, and output a first key-value generated in the pre-filling operation; the memory controller is configured to: store the first key-value in the non-volatile memory device; obtain the first key-value from the non-volatile memory device to perform a decoding operation of large model reasoning, and store a second key-value generated in the decoding operation in the non-volatile memory device.

In some examples, the non-volatile memory device is configured to store the first key-value and the second key-value in a manner of storing one bit of data per memory cell.

In some examples, the non-volatile memory device comprises a three-dimensional NAND-type memory device.

In some examples, the decoding operation comprises a decoding attention operation and a decoding feedforward neural network operation; the memory controller is configured to: perform the decoding attention operation; and store the second key-value generated in the decoding attention operation in the non-volatile memory device.

In some examples, the memory controller is configured to: perform the decoding feedforward neural network operation.

In some examples, the processor is configured to: obtain corresponding first query, key, and value based on each of the tokens in a prompt in a user input; the first key-value comprises the corresponding key and value obtained based on each of the tokens in the prompt in the user input.

In some examples, the non-volatile memory device is configured to store a first weight required in the decoding attention operation and a second weight required in the decoding feedforward neural network operation.

In some examples, the decoding operation comprises a decoding attention operation and a decoding feedforward neural network operation; the memory controller is configured to: obtain a first weight required in the decoding attention operation; in the decoding attention operation, generate a projection output and the second key-value based on the first key-value and the first weight.

In some examples, in the decoding attention operation, the memory controller is configured to: generate corresponding second query, key, and value based on the first weight and the input vector; the second key-value comprises the corresponding key and value generated based on the first weight and the input vector; obtain an attention score based on the key in the first key-value, the key in the second key-value, and the second query; obtain an attention weight based on the attention score; obtain a weighted output based on the attention weight, the value in the first key-value, and the value in the second key-value; obtain the projection output based on the weighted output and the first weight.

In some examples, the memory controller is configured to: obtain a second weight required in the decoding feedforward neural network operation; in the decoding feedforward neural network operation, generate a reasoning output result based on the second weight and the projection output; the processor is configured to: receive the reasoning output result.

In some examples, the system comprises a memory system and a host coupled to the memory system; the memory system comprises the non-volatile memory device, the memory controller and a first interface circuit, the host comprises the processor and a second interface circuit; the memory controller interacts with the processor through the first interface circuit and the second interface circuit.

In some examples, the host further comprises a volatile memory device coupled to the processor.

According to a second aspect of an example of the present disclosure, a memory system is provided, comprising: a non-volatile memory device and a memory controller coupled to the non-volatile memory device; the memory controller is configured to: receive a first key-value, and store the first key-value in the non-volatile memory device; the first key-value comprises a key and a value generated in a pre-filling operation for performing large model reasoning; obtain the first key-value from the non-volatile memory device to perform a decoding operation of the large model reasoning, and store a second key-value generated in the decoding operation in the non-volatile memory device.

In some examples, the non-volatile memory device is configured to store the first key-value and the second key-value in a manner of storing one bit of data per memory cell.

In some examples, the non-volatile memory device comprises a three-dimensional NAND-type memory device.

In some examples, the decoding operation comprises a decoding attention operation and a decoding feedforward neural network operation; the memory controller is configured to: perform the decoding attention operation; and store the second key-value generated in the decoding attention operation in the non-volatile memory device.

In some examples, the memory controller is configured to perform the decoding feedforward neural network operation.

In some examples, the non-volatile memory device is configured to store a first weight required in the decoding attention operation and a second weight required in the decoding feedforward neural network operation.

In some examples, the decoding operation comprises a decoding attention operation and a decoding feedforward neural network operation; the memory controller is configured to: obtain a first weight required in the decoding attention operation; in the decoding attention operation, generate a projection output and the second key-value based on the first key-value and the first weight.

In some examples, the memory controller is configured to: obtain a second weight required in the decoding feedforward neural network operation; in the decoding feedforward neural network operation, generate a reasoning output result based on the second weight and the projection output.

According to a third aspect of an example of the present disclosure, a method of operating a system is provided, comprising: performing a pre-filling operation of large model reasoning through a processor, and outputting a first key-value generated in the pre-filling operation; storing the first key-value in a non-volatile memory device coupled to the memory controller through a memory controller; and obtaining the first key-value from the non-volatile memory device by the memory controller to perform a decoding operation of the large model reasoning, and storing the second key-value generated in the decoding operation in the non-volatile memory device.

In some examples, the non-volatile memory device is configured to store the first key-value and the second key-value in a manner of storing one bit of data per memory cell.

In some examples, the non-volatile memory device comprises a three-dimensional NAND-type memory device.

In some examples, the decoding operation comprises a decoding attention operation and a decoding feedforward neural network operation; performing the decoding operation of the large model reasoning by the memory controller, and storing the second key-value generated in the decoding operation in the non-volatile memory device, comprises: performing the decoding attention operation by the memory controller; storing the second key-value generated in the decoding attention operation in the non-volatile memory device by the memory controller.

In some examples, performing the decoding operation of the large model reasoning by the memory controller comprises: performing the decoding feedforward neural network operation by the memory controller.

In some examples, performing the pre-filling operation of large model reasoning by the processor comprises: by the processor obtaining the corresponding first query, key, and value based on each of the tokens in the prompt in the user input; the first key-value comprises the corresponding key and value obtained based on each of the tokens in the prompt in the user input.

In some examples, the non-volatile memory device is configured to store a first weight required in the decoding attention operation and a second weight required in the decoding feedforward neural network operation.

In some examples, the decoding operation comprises a decoding attention operation and a decoding feedforward neural network operation; the method of operating a system also comprises: obtaining a first weight required in the decoding attention operation by the memory controller; performing the decoding attention operation by the memory controller comprises: by the memory controller generating a projection output and the second key-value based on the first key-value and the first weight.

In some examples, by the memory controller generating a projection output and the second key-value based on the first key-value and the first weight, comprises: by the memory controller generating corresponding second query, key, and value based on the first weight and the input vector; the second key-value comprises the corresponding key and value generated based on the first weight and the input vector; by the memory controller obtaining an attention score based on the key in the first key-value, the key in the second key-value, and the second query; by the memory controller obtaining an attention weight based on the attention score; by the memory controller obtaining a weighted output based on the attention weight, the value in the first key-value, and the value in the second key-value; by the memory controller obtaining the projection output based on the weighted output and the first weight.

In some examples, the method of operating a system also comprises: by the memory controller obtaining a second weight required in the decoding feedforward neural network operation; by the memory controller performing a decoding operation of large model reasoning, comprises: in the decoding feedforward neural network operation, generating a reasoning output result based on the second weight and the projection output; and receiving the reasoning output result by the processor.

According to a fourth aspect of an example of the present disclosure, a method of operating a memory system is provided, comprises: receiving a first key-value, and storing the first key-value in a non-volatile memory device; the first key-value comprises a key and a value generated in a pre-filling operation for performing large model reasoning; obtaining the first key-value from the non-volatile memory device to perform a decoding operation of the large model reasoning, and storing a second key-value generated in the decoding operation in the non-volatile memory device.

In some examples, the non-volatile memory device is configured to store the first key-value and the second key-value in a manner of storing one bit of data per memory cell.

In some examples, the non-volatile memory device comprises a three-dimensional NAND-type memory device.

In some examples, the decoding operation comprises a decoding attention operation and a decoding feedforward neural network operation; performing a decoding operation of large model reasoning, and storing a second key-value generated in the decoding operation in the non-volatile memory device, comprises: performing the decoding attention operation; storing the second key-value generated in the decoding attention operation in the non-volatile memory device.

In some examples, performing a decoding operation of large model reasoning comprises: performing the decoding feedforward neural network operation.

In some examples, the non-volatile memory device is configured to store a first weight required in the decoding attention operation and a second weight required in the decoding feedforward neural network operation.

In some examples, the decoding operation comprises a decoding attention operation and a decoding feedforward neural network operation; the method of operating a memory system also comprises: obtaining a first weight required in the decoding attention operation; performing a decoding operation of large model reasoning, comprises: in the decoding attention operation, generating a projection output and the second key-value based on the first key-value and the first weight.

In some examples, the method of operating a memory system also comprises: obtaining a second weight required in the decoding feedforward neural network operation; performing a decoding operation of large model reasoning, comprises: in the decoding feedforward neural network operation, generating a reasoning output result based on the second weight and the projection output.

According to a fifth aspect of an example of the present disclosure, a computer-readable storage medium is provided, on which computer program is stored thereon. When the computer program is executed by a processor, the method of operating the system as described in any of the above examples and the method of operating the memory system as described in any of the above examples are performed.

### BRIEF DESCRIPTION OF THE DRAWINGS

FIG. 1 is a schematic diagram 1 of an example system with a memory system according to an example of the present disclosure;

FIG. 2 is a schematic diagram of an example memory card with a memory system according to an example of the present disclosure;

FIG. 3 is a schematic diagram of an example solid-state drive with a memory system according to an example of the present disclosure;

FIG. 4 is a schematic diagram of an example memory device comprising a peripheral circuit according to an example of the present disclosure;

FIG. 5 is a schematic diagram of an example memory comprising a memory array and a peripheral circuit according to an example of the present disclosure;

FIG. 6 is a schematic diagram 2 of an example system with a memory system according to an example of the present disclosure;

FIG. 7 is a schematic diagram 1 of a system provided by an example of the present disclosure;

FIG. 8 is a schematic diagram 2 of a system provided by an example of the present disclosure;

FIG. 9 is a flow chart of a decoding operation provided by an example of the present disclosure;

FIG. 10 is a schematic diagram of a memory system provided by an example of the present disclosure;

FIG. 11 is a flow chart of a method of operating a system provided by an example the present disclosure;

FIG. 12 is a flow chart of a method of operating a memory system provided by an example of the present disclosure;

FIG. 13 is a schematic diagram of a computer-readable storage medium provided by an example of the present disclosure.

### DETAILED DESCRIPTION

Examples of the present disclosure will be described in more detail below with reference to the accompanying drawings. Although examples of the present disclosure are shown in the drawings, it should be understood that the present disclosure may be implemented in various ways and should not be limited to the DETAILED DESCRIPTION set forth herein. Rather, these examples are provided so that the present disclosure can be more thoroughly understood and the scope of the present disclosure can be fully conveyed to those skilled in the art.

In the following description, numerous specific details are given in order to provide a more thorough understanding of the present disclosure. It will be apparent, however, to one skilled in the art that the present disclosure may be practiced without one or more of these details. In other examples, some technical features well-known in the art are not described to avoid confusion with the present disclosure; that is, not all features of the actual example are described here, and well-known functions and structures are not described in detail.

In the accompanying drawings, the same reference numerals represent the same elements throughout.

It should be understood that, spatial relationship terms such as “under”, “below”, “beneath”, “underneath”, “on”, “above” and so on, can be used here for convenience to describe the relationship between one element or feature and other elements or features shown in the figures. It will be understood that the spatially relationship terms also comprise different orientations of the device in use and operation in addition to the orientation depicted in the figures. For example, if the device in the figures is turned over, elements or features described as “below” or “underneath” or “under” other elements or features would then be oriented as “above” the other elements or features. Thus, the example terms “below” and “under” can comprise both orientations of above and below. The device may be otherwise oriented (rotated 90 degrees or at other orientations) and the spatial description terms used herein may be interpreted accordingly.

The terminology used herein is for the purpose of describing particular examples only and is not to be taken as a limitation of the present disclosure. As used herein, “a”, “an” and “said/the” in singular forms are intended to include the plural forms as well, unless the context clearly dictates otherwise. It should also be understood that at least one of the terms “consist of” or “comprise”, when used in this specification, identify the presence of at least one of stated features, integers, operations, elements or components, but do not exclude presence or addition of at least one of one or more other features, integers, operations, elements, components or groups. As used herein, the term “at least one of . . . ” includes any and all combinations of the associated listed items.

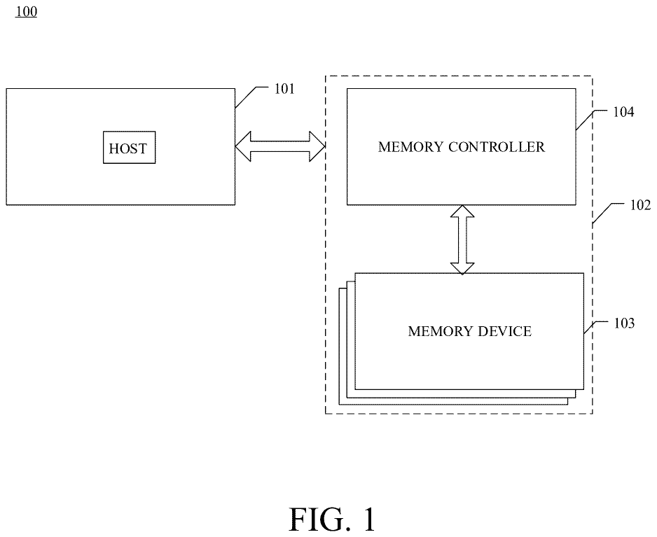

FIG. 1 is a schematic diagram of an example system with a memory system provided in an example of the present disclosure. In an example of the present disclosure, the system 100 may comprise a mobile phone, a desktop computer, a laptop, a tablet, a vehicle computer, a game console, a printer, a positioning device, a wearable electronic device, a smart sensor, a virtual reality (VR) device, an augmented reality (AR) device, or any other suitable electronic device having a memory therein. As shown in FIG. 1, the system 100 may comprise a host 101 and a memory system 102, wherein the memory system 102 may comprise one or more memory devices 103 and a memory controller 104. The host 101 may comprise a processor of an electronic device, such as a central processing unit (CPU), or a system on a chip (SoC), such as an application processor (AP). The host 101 may be configured to send data to the memory system 102 or receive data from the memory system 102.

In some examples, the memory controller 104 is coupled to the memory device 103 and the host 101, and is configured to control the memory device 103. The memory controller 104 can manage data stored in the memory device 103 and communicate with the host 101. In some examples, the memory controller 104 is designed to operate in a low duty cycle environment, such as in a secure digital card, a compact flash card (CFC), a universal serial bus (USB) flash drive, or in other media used in electronic devices such as personal computers, digital cameras, mobile phones, etc. In other examples, the memory controller 104 is designed to operate in a high duty cycle environment, such as a solid state drive or an embedded multimedia card (eMMC).

In some examples, the memory controller 104 and one or more memory devices 103 can be integrated into various types of storage devices, that is, the memory system 102 can be implemented and packaged into different types of end electronic products.

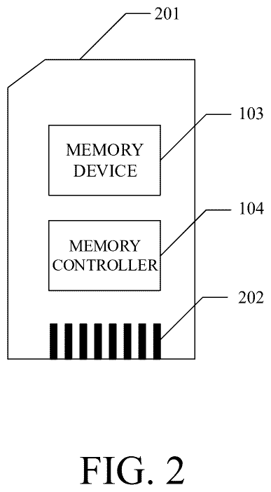

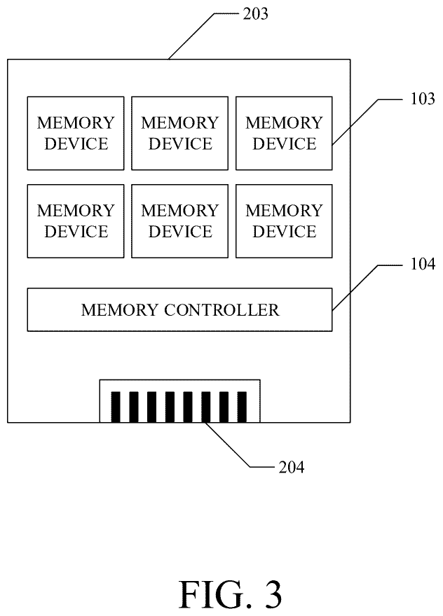

In an example as shown in FIG. 2, the memory controller 104 and a single memory device 103 can be integrated into a memory card 201. The memory card 201 may comprise a compact flash card, a smart media card (SMC), a memory stick (MS), a multimedia card (MMC), such as RS-MMC, MMCmicro, eMMC, etc., a secure digital card, such as a Mini SD card, a Micro SD card, an SDHC card, etc., or a general flash card. The memory card 201 may also comprise a memory card connector 202 that couples the memory card 201 with a host-side device (e.g., the host 101 in FIG. 1). In another example as shown in FIG. 3, the memory controller 104 and a plurality of memory devices 103 may be integrated into an SSD 203. The SSD 203 may also comprise an SSD connector 204 that couples the SSD 203 with a host-side device (e.g., the host 101 in FIG. 1). In some examples, at least one of the storage capacity or operating speed of the SSD 203 is greater than that of the memory card 201.

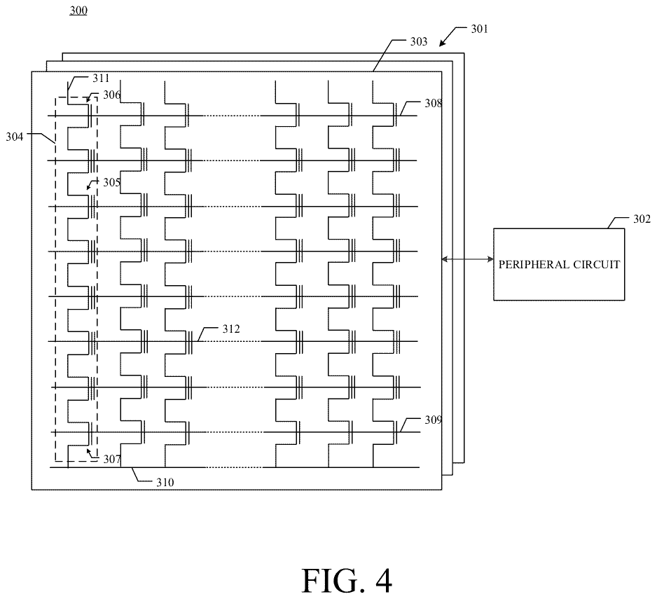

FIG. 4 is a circuit diagram of an example memory device 300 comprising a peripheral circuit as provided in an example of the present disclosure. The memory device 300 may be an example of the memory device 103 in FIG. 1. The memory device 300 may comprise a memory array 301 and a peripheral circuit 302 coupled to the memory array 301. The memory array 301 is taken as an example of a three-dimensional NAND type memory array for illustration, wherein the memory cell 305 is a NAND memory cell, and the memory cell 305 is provided in the form of an array of memory cell strings 304, wherein each memory cell string 304 extends vertically above a substrate (not shown). In some examples, each memory cell string 304 comprises a plurality of memory cells 305 coupled in series and stacked vertically. Each memory cell 305 may hold a continuous analog value, such as a voltage or charge, which depends on the number of electrons trapped in the region of the memory cell 305. Each memory cell 305 may be a floating gate type memory cell comprising a floating gate transistor, or a charge trap type memory cell comprising a charge trap transistor.

In some examples, each memory cell 305 is a single level cell (SLC) having two possible memory states and thus can store one bit of data. For example, the first memory state “0” can correspond to a first voltage range, and the second memory state “1” can correspond to a second voltage range. In some examples, each memory cell 305 is a multi-level cell capable of storing more than a single bit of data in four or more memory states, for example, a multi-level cell (MLC) storing two bits per cell, a triple level cell (TLC) storing three bits per cell, or a quad-level cell (QLC) storing four bits per cell.

As shown in FIG. 4, each memory cell string 304 can comprise a bottom select transistor (BST) 307 at its source end and a top select transistor (TST) 306 at its drain end. The bottom select transistor 307 and the top select transistor 306 can be configured to activate selected memory cell strings 304 during read and program operations. In some examples, the sources of the memory cell strings 304 in the same memory block 303 may be coupled via a common source line (Common Source Line, CSL) 310. In other words, all memory cell strings 304 in the same memory block 303 have an array common source (ACS). According to some examples, the top selection transistor 306 of each memory cell string 304 is coupled to a corresponding bit line (BL) 311, and data can be read from or written to the bit line 311 via an output bus (not shown). In some examples, each memory cell string 304 is configured to be selected or deselected by at least one of applying a select voltage (e.g., a voltage higher than a threshold voltage of the top select transistor 306) or a deselect voltage (e.g., 0V) to a top select gate (TSG) of the corresponding top select transistor 306 through one or more top select lines (TSL) 308 or applying a select voltage (e.g., a voltage higher than a threshold voltage of the bottom select transistor 307) or a deselect voltage (e.g., 0V) to a bottom select gate (BSG) of the corresponding bottom select transistor 307 through one or more bottom select lines (BSL) 309.

As shown in FIG. 4, the memory cell strings 304 can be organized into a plurality of memory blocks 303, each of which can have a common source line 310. In some examples, each memory block 303 is a basic data unit for an erase operation, i.e., all memory cells 305 on the same memory block 303 are erased at the same time. To erase the memory cells 305 in the selected memory block, a common source line 310 coupled to the selected memory block and unselected memory blocks in the same plane as the selected memory block may be biased with an erase voltage. It should be understood that in some examples, the erase operation may be performed at a half-memory block level, at a quarter-memory block level, or at a level having any suitable number of memory blocks or any suitable fractions of a memory block. The memory cells 305 of adjacent memory cell strings 304 may be coupled via word lines 312, which select which row of memory cells 305 is affected by read or program operations.

In some examples, the peripheral circuit 302 may comprise any suitable analog, digital, and mixed-signal circuits for enabling the operations of the memory array 301 by applying and sensing at least one of voltage signals or current signals to and from each target memory cell 305 through bit lines 311, word lines 312, common source lines 310, bottom select lines 309, and top select lines 308 to implement operation of the memory array 301. The peripheral circuit 302 may comprise various types of peripheral circuits formed using metal-oxide-semiconductor technology.

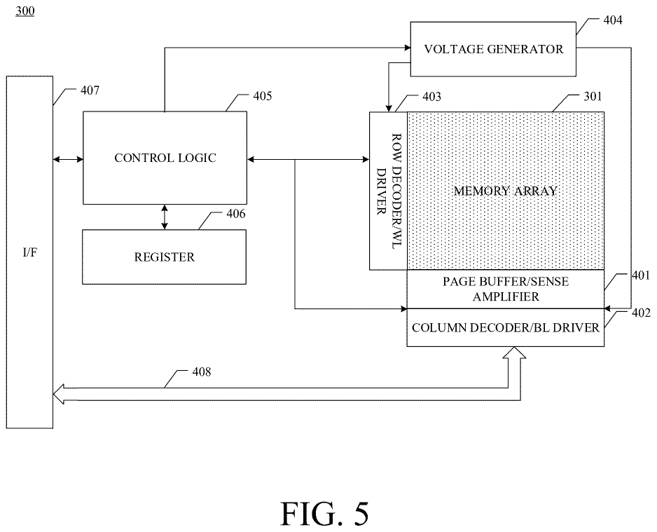

FIG. 5 shows some example peripheral circuits, and the peripheral circuit 302 comprises a page buffer/sense amplifier 401, a column decoder/bit line driver 402, a row decoder/word line driver 403, a voltage generator 404, a control logic 405, a register 406, a flash memory interface 407, and a data bus 408. It should be understood that in some examples, additional peripheral circuits not shown in FIG. 5 may also be comprised.

The page buffer/sense amplifier 401 can be configured to read data from the memory array 301 and program (write) data to the memory array 301 according to a control signal from the control logic 405. In one example, the page buffer/sense amplifier 401 can store a page of program data (write data) to be programmed into the memory array 301. In another example, the page buffer/sense amplifier 401 can perform a program verify operation to ensure that the data has been correctly programmed into the memory cells coupled to the selected word line. In yet another example, the page buffer/sense amplifier 401 can also sense the low power signals from the bit line that represent data bits stored in the memory cells and amplify the small voltage swing to recognizable logic levels in a read operation. The column decoder/bit line driver 402 can be configured to be controlled by the control logic 405 and select one or more memory cell strings 304 by applying bit line voltages generated from the voltage generator 404.

The row decoder/word line driver 403 can be configured to be controlled by the control logic 405 and select/deselect memory blocks of the memory array 301 and select/deselect word lines of memory blocks. The row decoder/word line driver 403 can be further configured to drive word lines using word line voltages generated from the voltage generator 404. In some examples, the row decoder/word line driver 403 can also select/deselect and drive bottom select lines and top select lines as well. As described below in detail, the row decoder/word line driver 403 is configured to perform program operations on the memory cells coupled to the selected word line(s). The voltage generator 404 can be configured to be controlled by the control logic 405 and generate the word line voltages (e.g., read voltages, program voltages, pass voltages, local voltages, verification voltages, etc.), bit line voltages, and source line voltages to be supplied to the memory array 301.

The control logic 405 may be implemented in the peripheral circuit described above and coupled to various parts in the peripheral circuit, and the control logic 405 may be configured to control the operation of each peripheral circuit. The register 406 may be coupled to the control logic 405, and includes a status register, a command register, and an address register for storing status information, a command operation code (OP code), and a command address for controlling the operation of each peripheral circuit. The flash memory interface 407 may be coupled to the control logic 405, and act as a control buffer to buffer control commands received from a host-side device (not shown) and relay them to the control logic 405, and to buffer status information received from the control logic 405 and relay them to the memory controller. The flash memory interface 407 may also be coupled to the column decoder/bit line driver 402 via the data bus 408, and act as a data I/O interface and a data buffer to buffer data and relay them to the memory array 301 or relay or buffer data from the memory array 301.

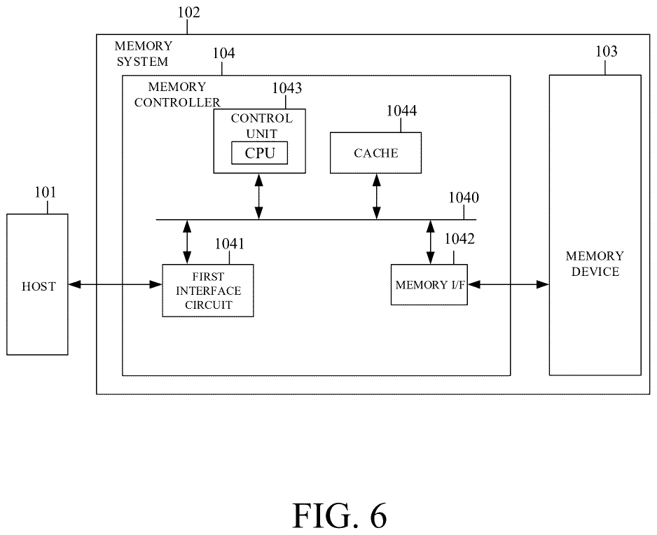

FIG. 6 is a schematic diagram of a system comprising a host and a memory system provided by an example of the present disclosure. As shown in FIG. 6, a memory system 102 is connected to a host 101, wherein the memory system 102 may comprise: a memory controller 104 and a memory device 103, wherein the memory controller 104 is configured to control the memory device 103 to perform operations such as read, write, and erase, and the memory controller 104 and the memory device 103 may also be coupled in any suitable manner. The memory controller 104 may comprise a first interface circuit 1041, a memory interface (I/F) 1042, a control unit 1043, a cache 1044, and a bus 1040. Among them, the first interface circuit 1041 may be a connection interface between the host 101 and the memory controller 104, and the first interface circuit 1041 allows the host 101 and the memory controller 104 to communicate according to a specific protocol, send read and write requests, and perform other operations. The memory interface 1042 may be a connection interface between the memory controller 104 and the memory device 103, and the memory interface 1042 is configured to enable data and command transmission between the memory controller 104 and the memory device 103. The control unit 1043 is configured to control the memory system 102 as a whole.

In some specific examples, the control unit 1043 may comprise one or more units with logical operation capabilities, such as at least one of a central processing unit (CPU) or a microcontroller unit (MCU).

In some specific examples, the cache 1044 is configured to cache data, and may be a volatile memory device with a relatively fast read and write speed, such as at least one of a static random access memory (SRAM) or a dynamic random access memory (DRAM).

With the rapid development of computer technology, large models can play their role in many scenarios due to their outstanding data processing capabilities. Large model reasoning can be divided into many types according to the type of model, application scenario and optimization method, each type has its own unique characteristics and applicable scenarios. The following are several common types of large model reasoning and their characteristics: 1. General large model, which is characterized in: focusing on language generation, context understanding and natural language processing; through training on massive text data, mastering the laws of language and generating content that conforms to the context; performing well in tasks such as text generation, translation, question answering, and summarization; its application scenarios include text generation, machine translation, and question answering systems. 2. Reasoning large model, which is characterized in: based on the traditional large language model, it is built by strengthening reasoning, logical analysis and decision-making capabilities; integrating technical means such as reinforcement learning, neural symbolic reasoning, and meta-learning to improve complex problem-solving capabilities; performing well in logical reasoning, mathematical derivation and real-time problem solving; its application scenarios include mathematical proof, logical analysis, and complex problem solving. 3. Multimodal large models, whose characteristics are: able to process multiple types of input data, such as text, images, audio, video, etc. ; understand the relationship between different modal data through cross-modal learning; able to generate outputs of multiple modalities, such as generating images based on text, or generating descriptions based on images; its application scenarios include cross-modal retrieval, visual question answering, and image description generation. 4. Domain-specific large models, whose characteristics are: optimized for specific industries or fields, using industry-related data for pre-training or fine-tuning; improving performance and accuracy in specific fields; application scenarios include medical diagnosis, financial analysis, and legal consulting. 5. Coding large models, whose characteristics are: focusing on code generation and programming assistance; learning the syntax and logic of programming languages by training on code repositories; application scenarios include code generation, programming assistance, and code completion.

The emergence and rapid development of large models have brought revolutionary changes to the field of artificial intelligence. The core processes of the above-mentioned various types of large model reasoning can include two major segments: the pre-filling phase and the decoding phase. The execution of operations related to large model inference depends on corresponding hardware.

The pre-filling phase is the process from inputting the prompt by the user to generating a first output token. It is mainly responsible for processing the input text, calculating and caching the key and value, and generating the first output token. The process of the pre-filling phase includes: (i) input processing: after entering a complete text prompt by the user, the model (for example, the corresponding hardware relied upon by the operations related to large models) may split the input prompt into individual tokens; (ii) forward propagation calculation: performing forward propagation calculations on these input tokens by the model (for example, the corresponding hardware relied upon by the operations related to large models). During this process, the model (for example, the corresponding hardware relied upon by the operations related to large models) may calculate and cache the key and value corresponding to each token. These keys and values may be used in the subsequent decoding phase to accelerate the generation of subsequent tokens; (iii) generating the first output token: based on the forward propagation results of the input token, the model (for example, the corresponding hardware relied upon by the operations related to large models) may predict and generate the first output token. This first output token is the first output content predicted by the model (for example, the corresponding hardware relied upon by the operations related to large models) from the semantics and contextual information of the input prompt; (iv) output and cache: after the first output token is generated, the model (for example, the corresponding hardware relied upon by the operations related to large models) may output the first output token; at the same time, the model (for example, the corresponding hardware relied upon by the operations related to large models) may cache the calculated Key and Value in the key-value cache (KV Cache). These cached information may be used in the subsequent decoding phase to help the model (for example, the corresponding hardware relied upon by the operations related to large models) generate subsequent output tokens more efficiently.

The decoding phase is mainly responsible for generating subsequent output tokens one by one after the first output token is generated until the condition for stopping the reasoning is met. The decoding phase is a cyclic iterative process, and an output token is generated in each iteration until at least one of the stopping conditions is met, such as reaching the maximum output length, generating a terminator, or other custom conditions. In each iteration, the output token generated in the previous round is taken as the current input, and the probability distribution of the next output token may be calculated in combination with the previously cached keys and values. A token is selected from the probability distribution (generally the token with the highest probability) as the output of the current round of iteration. In each iteration, the key and value of the newly generated output token may be updated to the KV Cache for use in the next iteration.

In some examples, the keys and values generated in the pre-filling phase and the decoding phase are cached in a volatile memory device in the host, that is, the volatile memory device in the host may be used as a KV Cache, wherein the volatile memory device is a dynamic random access memory such as a Low Power Double Data Rate SDRAM (LPDDR) and a Video Random Access Memory (VRAM). As the data processed in large model reasoning becomes larger, demanding for the capacity of KV Cache becomes more, such that the cost of KV Cache increases. In some application scenarios, the capacity of KV Cache is close to or even exceeds the capacity of the volatile memory device in the host itself in some cases. How to reduce the cost of KV Cache has become an urgent problem to be solved at this stage.

In this regard, the present disclosure proposes the following implementations.

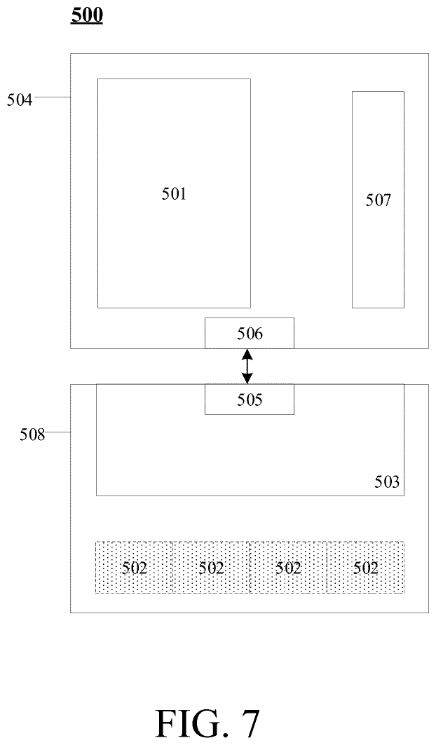

The present disclosure provides a system. FIG. 7 is a schematic diagram of a system provided by an example of the present disclosure. As shown in FIG. 7, the system 500 includes a processor 501, a non-volatile memory device 502, and a memory controller 503 coupled to the non-volatile memory device 502; wherein the processor 501 is configured to: perform a pre-filling operation of large model reasoning, and output a first key-value generated in the pre-filling operation; the memory controller 503 is configured to: store the first key-value in the non-volatile memory device 502; obtain the first key-value from the non-volatile memory device 502 to perform a decoding operation of the large model reasoning, and store the second key-value generated in the decoding operation in the non-volatile memory device 502.

In the example of the present disclosure, the processor 501 may perform a pre-filling operation of the large model reasoning and generate a first key-value; the memory controller 503 may store the first key-value in the non-volatile memory device 502; and the memory controller 503 may obtain the first key-value from the non-volatile memory device 502 to perform a decoding operation of the large model reasoning, and the memory controller 503 may store the second key-value generated in the decoding operation in the non-volatile memory device 502. That is, in the example of the present disclosure, both the first key-value and the second key-value generated in the large model reasoning process may be stored in the non-volatile memory device 502, and the memory controller 503 may directly obtains the first key-value from the non-volatile memory device 502 coupled to the memory controller 503. In the example of the present disclosure, the non-volatile memory device 502 is taken as a key-value cache, so that the capacity and cost issues of caching the key-value in the large model reasoning process may be improved.

In the example of the present disclosure, large model reasoning may process various types of data, including but not limited to text data, audio data, video data, structured data, code data, and multimodal data.

In some examples, the processor 501 includes but is not limited to a CPU, a graphics processing unit (GPU), a tensor processing unit (TPU), and a neural network processing unit (NPU).

In the example of the present disclosure, system 500 includes, but is not limited to, a mobile phone, a desktop computer, a laptop computer, a tablet computer, a vehicle computer, a game console, a printer, a positioning device, a wearable electronic device, a smart sensor, a virtual reality device, an augmented reality device, or any other suitable electronic device having a memory therein.

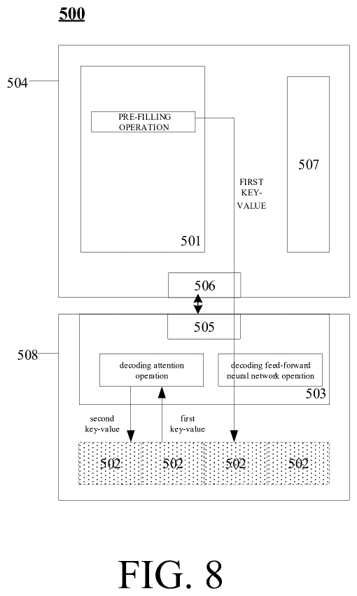

In some examples, as shown in FIG. 8, the processor 501 may perform a pre-filling operation to generate a first key-value, the processor 501 may output the first key-value to the memory controller 503, and the memory controller 503 may store the first key-value in the non-volatile memory device 502.

In some examples, the processor 501 is configured to: obtain corresponding first query, key, and value based on each of the tokens in the prompt in the user input; the first key-value includes the corresponding key and value obtained based on each of the tokens in the prompt in the user input.

In the example of the present disclosure, after the user inputs a complete text prompt, the text prompt may be segmented into individual tokens by a word segmenter, and these tokens may be converted into numerical forms that the system may understand. The processor 501 may perform forward propagation calculations on these input tokens, and based on each of the tokens in the prompt in the user input, calculate the key, value, and first query corresponding to each of the input tokens. The first key-value may include the corresponding key and value obtained based on each of the tokens in the prompt in the user input in the pre-filling operation, the first key-value is output to the memory controller 503 by the processor 501, and is stored by the memory controller 503 in the non-volatile memory device 502 coupled to the memory controller 503, for use in the subsequent decoding phase to accelerate the generation of output tokens in subsequent decoding operations.

In some examples, non-volatile memory device 502 comprises a three-dimensional NAND-type memory device.

It may be understood that three-dimensional NAND memory device may better meet the capacity and cost requirements for key-value cache in a big data environment due to its low cost and large capacity.

In some examples, the system 500 includes one or more non-volatile memory devices 502 to which a memory controller 503 is coupled.

In some examples, the non-volatile memory device 502 is configured to store the first key-value and the second key-value in a manner of storing one bit of data per memory cell.

It may be understood that in the example of the present disclosure, the non-volatile memory device 502 is configured to store the first key-value and the second key-value in a manner of storing one bit of data per memory cell. The memory cell of the non-volatile memory device 502 has a faster reading and writing speed in the mode of storing one bit of data, thereby improving the efficiency of large model reasoning and saving reasoning time.

In the example of the present disclosure, the non-volatile memory device 502 is not limited to the three-dimensional NAND memory device given in the above example. In the example of the present disclosure, the non-volatile memory device 502 may also include a non-volatile memory device such as a three-dimensional phase change memory.

It may be understood that the three-dimensional phase change memory device also has a fast reading and writing speed, and a relatively large capacity, a relatively low cost, and can meet the capacity and efficiency requirements for large model reasoning.

In some examples, the decoding operation includes a decoding attention operation and a decoding feedforward neural network operation.

In some examples, the memory controller 503 is configured to: perform a decoding attention operation; store the second key-value generated in the decoding attention operation in the non-volatile memory device 502.

As shown in FIG. 8, in the example of the present disclosure, the decoding attention operation may be performed by the memory controller 503. The memory controller 503 may store the second key-value generated in the decoding attention operation in the non-volatile memory device 502.

It may be understood that, based on the first key-value and the second key-value being stored in the non-volatile memory device 502, the decoding attention operation performed by the memory controller 503 coupled to the non-volatile memory device 502 may shorten the time for obtaining the first key-value from the non-volatile memory device 502 and storing the second key-value in the non-volatile memory device 502, thereby shortening the data transmission time in the decoding attention operation, thereby improving the execution efficiency of the decoding attention operation.

In some examples, the above-mentioned decoding attention operation can be performed by a control unit in the memory controller 503.

In some examples, as shown in FIG. 8, the memory controller 503 is configured to: perform a decoding feedforward neural network operation.

In some examples, the decoding feedforward neural network operation may be performed by a control unit in the memory controller 503.

It may be understood that, based on the memory controller 503 performing the decoding attention operation, the memory controller 503 may perform the decoding feedforward neural network operation, so that the projection output generated by the memory controller performing the decoding attention operation may be directly used for the memory controller 503 to perform the decoding feedforward neural network operation, thereby improving the efficiency of performing the decoding feedforward neural network operation.

In some examples, processor 501 is configured to: perform a decoding attention operation and perform a decoding feedforward neural network operation.

In some examples, the decoding attention operation can be performed by one of the memory controller 503 and the processor 501, the decoding feedforward neural network operation may be performed by the other of the memory controller 503 and the processor 501. For example, the processor 501 is configured to perform the decoding attention operation, the memory controller 503 is configured to perform the decoding feedforward neural network operation. In some examples: the memory controller 503 obtains a first key-value from the non-volatile memory device 502, and sends the obtained first key-value to the processor 501, and the processor 501 is configured to obtain a first weight required in the decoding attention operation. The processor 501 may generate a projection output and a second key-value based on the first key-value and the first weight required in the decoding attention operation. The processor 501 may send the second key-value and the projection output to the memory controller 503. The memory controller 503 may store the second key-value in the non-volatile memory device 502, and the memory controller 503 may perform the decoding feedforward neural network operation based on the projection output.

It may be understood that in the above example, the decoding attention operation and the decoding feedforward neural network operation may be performed by different execution entities, which makes resource allocation more balanced.

The decoding attention operation and the decoding feedforward neural network operation are further explained below by taking the decoding attention operation performed by the memory controller 503 and the decoding feedforward neural network operation performed by the memory controller 503 as an example.

In some examples, the decoding operation includes a decoding attention operation and a decoding feedforward neural network operation; the memory controller 503 is configured to: obtain a first weight required in the decoding attention operation; in the decoding attention operation, generate a projection output and a second key-value based on the first key-value and the first weight.

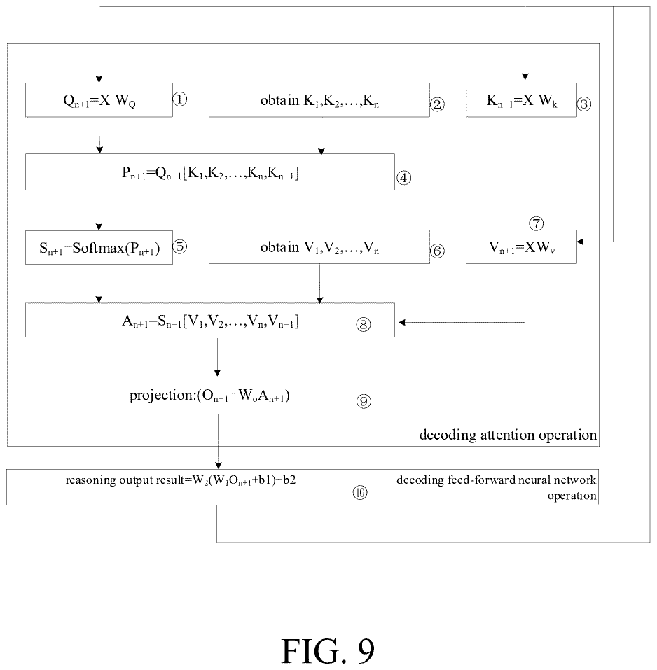

In the example of present disclosure, the decoding phase is a cyclic iterative process. FIG. 9 shows a schematic diagram of a process of one round of iteration of the decoding operation. As shown in FIG. 9, the decoding operation includes a decoding attention operation and a decoding feedforward neural network operation. In the decoding attention operation phase, the memory controller 503 may obtain the first weight required in the decoding attention operation, wherein the first weight includes a weight (W_{Q}) associated with the query, a weight (Wₖ) associated with the key, a weight (Wᵥ) associated with the value, and an attention weight (Wo), each of which may be a matrix or a vector, including multiple elements.

In some examples, the non-volatile memory device 502 is configured to store first weights required in a decoding attention operation.

In some examples, the memory controller 503 is configured to: obtain a first weight required in a decoding attention operation from the non-volatile memory device 502; in the decoding attention operation, generate a projection output and a second key-value based on the first key-value and the first weight.

It may be understood that in the example of the present disclosure, in case that the decoding attention operation is performed by the memory controller 503, the first weight required in the decoding attention operation may be stored in the non-volatile memory device 502 coupled to the memory controller 503, and the memory controller 503 may directly obtain the first weight from the non-volatile memory device 502 when performing the decoding attention operation, thereby shortening the time for obtaining the first weight, thereby improving the reasoning efficiency.

In some examples, as shown in FIG. 6, the memory controller includes a cache 1044 configured to store a first weight required in a decoding attention operation.

In some examples, the memory controller is configured to: obtain a first weight required in a decoding attention operation from a cache; in the decoding attention operation, generate a projection output and a second key-value based on the first key-value and the first weight.

It may be understood that in the example of the present disclosure, in case that the decoding attention operation is performed by the memory controller 503, the first weight required in the decoding attention operation may also be stored in the cache in the memory controller 503. The memory controller 503 may directly obtain the first weight from the cache in the memory controller 503 when performing the decoding attention operation, so that the time for obtaining the first weight may be further shortened, and further improving the reasoning efficiency.

In some examples, in a decoding attention operation, the memory controller 503 is configured to: generate corresponding second query, key, and value based on the first weight and an input vector, wherein the second key-value includes the corresponding key and value generated based on the first weight and the input vector; obtain an attention score based on the key in the first key-value, the key in the second key-value, and the second query; obtain an attention weight based on the attention score; obtain a weighted output based on the attention weight, the value in the first key-value, and the value in the second key-value; and obtain a projection output based on the weighted output and the first weight.

As shown in FIG. 9, performing a decoding attention operation includes the following process: as shown in \textcircled{1} of FIG. 9, the input vector (X) is linearly transformed with a weight (W_{Q}) associated with the query to obtain a corresponding query (Qₙ₊₁); as shown in \textcircled{2} of FIG. 9, the memory controller may obtain relevant keys (K₁, K₂, . . . , Kₙ) from the non-volatile memory device 502, wherein K₁, K₂, . . . , Kₙ include the key in the first key-value generated by the pre-filling operation and the keys generated in the rounds of iteration before the current round of iteration in the decoding operation; as shown in \textcircled{3} of FIG. 9, the input vector (X) is linearly transformed with a weight (Wₖ) associated with the key to generate a corresponding key (Kₙ₊₁); as shown in \textcircled{4} of FIG. 9, the query vector (Qₙ₊₁) is dot-producted with all of the keys (including Kₙ₊₁ generated in the current round of iteration and K₁, K₂, . . . , Kₙ obtained from the non-volatile memory device 502) to obtain an attention score Pₙ₊₁; as shown in \textcircled{5} of FIG. 9, the Softmax function is applied to the attention score Pₙ₊₁ to obtain an attention weight Sₙ₊₁; as shown in \textcircled{6} of FIG. 9, the memory controller may obtain the relevant values (V₁, V₂, . . . , Vₙ) from the non-volatile memory device 502, wherein V₁, V₂, . . . , Vₙ include the value in the first key-value generated by the pre-filling operation and the values generated in the rounds of iteration before the current round of iteration in the decoding operation; as shown in \textcircled{7} of FIG. 9, the input vector (X) is linearly transformed with the weight (Wᵥ) associated with the value to obtain a corresponding value (Vₙ₊₁); as shown in \textcircled{8} of FIG. 9, all values (including Vₙ₊₁ generated in the current round of iteration, and V₁, V₂, . . . , Vₙ obtained from the non-volatile memory device 502) are weighted summed using the attention weight (Sₙ₊₁) to obtain a weighted output (Aₙ₊₁); as shown in \textcircled{9} of FIG. 9, Projection: the weighted output (Aₙ₊₁) is linearly transformed with the attention weight (Wo) to obtain a projection output (Oₙ₊₁). The key (Kₙ₊₁) and value (Vₙ₊₁) generated in the current round of iteration may be stored in the non-volatile memory device 502 for the next round of iteration.

In the example of the present disclosure, the second key-value may include the keys and values generated in corresponding rounds of iteration of the decoding attention operation.

In some examples, the memory controller 503 is configured to: obtain the second weight required in the decoding feedforward neural network operation; in the decoding feedforward neural network operation, generate a reasoning output result based on the second weight and the projection output; the processor 501 is configured to: receive the reasoning output result.

As shown in FIG. 9, in the decoding feedforward neural network operation phase, the memory controller 503 obtains the second weight required in the decoding feedforward neural network operation, wherein the second weight includes the weights (W₁ and W₂) of the feedforward neural network, and each of the above weights may be a matrix or a vector including multiple elements.

As shown in \textcircled{10} in FIG. 9, the projection output (Oₙ₊₁) is further processed by a feedforward neural network (containing two linear transformations and a nonlinear activation function) to obtain a reasoning output result (Output). Here, b1 and b2 are bias terms. The reasoning output result (Output) generated in the current round of iteration can be used for the next iteration.

In some examples, the non-volatile memory device 502 is configured to store the second weight required in decoding feedforward neural network operations.

In some examples, the memory controller 503 is configured to: obtain the second weight required in the decoding feedforward neural network operation from the non-volatile memory device 502; in the decoding feedforward neural network operation, generate a reasoning output result based on the second weight and the projection output.

It can be understood that in the example of the present disclosure, in case that the decoding feedforward neural network operation is performed by the memory controller 503, the second weight required in the decoding feedforward neural network operation can be stored in the non-volatile memory device 502 coupled to the memory controller 503, the memory controller 503 can directly obtain the second weight from the non-volatile memory device 502 when performing the decoding feedforward neural network operation, so that the time for obtaining the second weight can be shortened to improve the reasoning efficiency.

In some examples, the memory controller 503 includes a cache configured to store second weights required in decoding feedforward neural network operations.

In some examples, the memory controller 503 is configured to: obtain the second weight required in the decoding feedforward neural network operation from the cache; in the decoding feedforward neural network operation, generate a reasoning output result based on the second weight and the projection output.

It can be understood that in the example of the present disclosure, in case that the decoding feedforward neural network operation is performed by the memory controller 503, the second weight required in the decoding feedforward neural network operation can also be stored in the cache in the memory controller 503. The memory controller 503 can directly obtain the second weight from the cache in the memory controller 503 when performing the decoding feedforward neural network operation, so that the time for obtaining the second weight can be further shortened, to further improve the reasoning efficiency.

In some examples, as shown in FIG. 7 and FIG. 8, the system 500 includes a memory system 508 and a host 504 coupled to the memory system 508; the memory system 508 includes a non-volatile memory device 502, a memory controller 503 and a first interface circuit 505, the host 504 includes a processor 501 and a second interface circuit 506; the memory controller 503 interacts with the processor 501 through the first interface circuit 505 and the second interface circuit 506.

In some examples, as shown in FIG. 7 and FIG. 8, the host 504 further includes a volatile memory device 507. The volatile memory device 507 is coupled to the processor 501.

The volatile memory device 507 includes, but is not limited to, random access memory (RAM), dynamic random access memory, static random access memory (SRAM), synchronous dynamic random access memory (SDRAM), Double Data Rate Synchronous Dynamic Random Access Memory (DDR SDRAM).

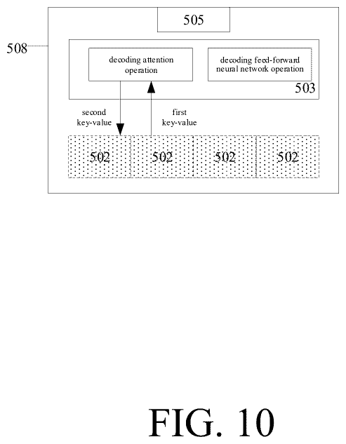

Based on the above system, an example of the present disclosure also provides a memory system 508, as shown in FIG. 10, the memory system comprises: a non-volatile memory device 502 and a memory controller 503 coupled to the non-volatile memory device 502; the memory controller 503 is configured to: receive a first key-value, and store the first key-value in the non-volatile memory device 502; the first key-value comprises a key and a value generated in a pre-filling operation for performing large model reasoning; obtain the first key-value from the non-volatile memory device 502 to perform a decoding operation of large model reasoning, and store the second key-value generated in the decoding operation in the non-volatile memory device 502.

In the example of the present disclosure, the memory controller 503 receives the first key-value generated in the pre-filling operation, and the memory controller 503 stores the first key-value in the non-volatile memory device 502; and the memory controller 503 obtains the first key-value from the non-volatile memory device 502 to perform the decoding operation of the large model reasoning, and the memory controller 503 stores the second key-value generated in the decoding operation in the non-volatile memory device 502. That is, in the example of the present disclosure, both the first key-value and the second key-value generated in the large model reasoning process can be stored in the non-volatile memory device 502, the memory controller 503 directly obtains the first key-value from the non-volatile memory device 502 coupled to the memory controller 503. In the example of the present disclosure, the non-volatile memory device 502 is taken as a key-value cache, so that the capacity and cost issues of the key-value cache in the large model reasoning process may be improved.

In some examples, the non-volatile memory device 502 is configured to store the first key-value and the second key-value in a manner of storing one bit of data per memory cell.

In some examples, the non-volatile memory device 502 comprises a three-dimensional NAND-type memory device.

In some examples, the decoding operation comprises a decoding attention operation and a decoding feedforward neural network operation; the memory controller 503 is configured to: perform the decoding attention operation; store the second key-value generated in the decoding attention operation in the non-volatile memory device 502.

In some examples, the memory controller 503 is configured to: perform a decoding feedforward neural network operation.

In some examples, the non-volatile memory device 502 is configured to store a first weight required in a decoding attention operation and a second weight required in a decoding feedforward neural network operation.

In some examples, the decoding operation comprises a decoding attention operation and a decoding feedforward neural network operation; the memory controller 503 is configured to: obtain a first weight required in the decoding attention operation; in the decoding attention operation, generate a projection output and a second key-value based on the first key-value and the first weight.

In some examples, the memory controller 503 is configured to: obtain a second weight required in a decoding feedforward neural network operation; in the decoding feedforward neural network operation, generate a reasoning output result based on the second weight and the projection output.

Other details about the above memory system have been introduced in detail on the system side and will not be repeated here for the sake of brevity.

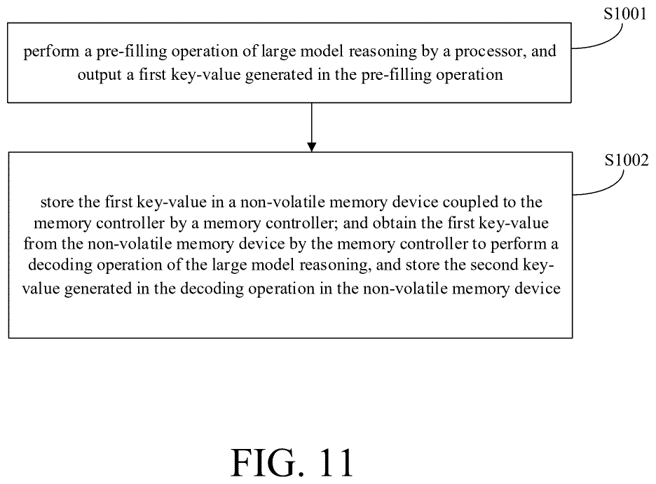

Based on the above system, an example of the present disclosure also provides a method of operating the system, as shown in FIG. 11, the method of operating the system comprises the following operations: operation S1001: perform a pre-filling operation of large model reasoning by a processor, and output a first key-value generated in the pre-filling operation; operation S1002: store the first key-value in a non-volatile memory device coupled to the memory controller by a memory controller; and obtain the first key-value from the non-volatile memory device by the memory controller to perform a decoding operation of the large model reasoning, and store the second key-value generated in the decoding operation in the non-volatile memory device.

In some examples, the non-volatile memory device is configured to store the first key-value and the second key-value in a manner of storing one bit of data per memory cell.

In some examples, the non-volatile memory device comprises a three-dimensional NAND-type memory device.

In some examples, the decoding operation comprises a decoding attention operation and a decoding feedforward neural network operation; performing a decoding operation of large model reasoning by a memory controller, and storing a second key-value generated in the decoding operation in a non-volatile memory device, comprises: performing a decoding attention operation by a memory controller; storing the second key-value generated in the decoding attention operation in a non-volatile memory device by the memory controller.

In some examples, performing a decoding operation of large model reasoning by a memory controller comprises: performing a decoding feedforward neural network operation by the memory controller.

In some examples, performing a pre-filling operation of large model reasoning by a processor comprises: by the processor obtaining corresponding first query, key, and value based on each of the tokens in a prompt in a user input; a first key-value comprises the corresponding key and value obtained based on each of the tokens in the prompt in the user input.

In some examples, the non-volatile memory device is configured to store a first weight required in a decoding attention operation and a second weight required in a decoding feedforward neural network operation.

In some examples, the decoding operation comprises a decoding attention operation and a decoding feedforward neural network operation; the operation method also comprises: obtaining a first weight required in the decoding attention operation by a memory controller; performing the decoding attention operation by the memory controller, comprises: by the memory controller generating a projection output and a second key-value based on the first key-value and the first weight.

In some examples, by the memory controller generating a projection output and a second key-value based on the first key-value and the first weight, comprises: by the memory controller generating corresponding second query, key and value based on the first weight and the input vector; the second key-value comprises the corresponding key and value generated based on the first weight and the input vector; by the memory controller obtaining an attention score based on the key in the first key-value, the key in the second key-value and the second query; by the memory controller obtaining an attention weight based on the attention score; by the memory controller obtaining a weighted output based on the attention weight, the value in the first key-value and the value in the second key-value; by the memory controller obtaining a projection output based on the weighted output and the first weight.

In some examples, the operation method also comprises: obtaining a second weight required in a decoding feedforward neural network operation by a memory controller; performing a decoding operation of large model reasoning by the memory controller, comprises: in the decoding feedforward neural network operation, generating a reasoning output result based on the second weight and the projection output; receiving the reasoning output result by a processor.

The method of operating the system mentioned in the above example has been described in detail in the aforementioned example of the system, and for the sake of brevity, it will not be repeated here.

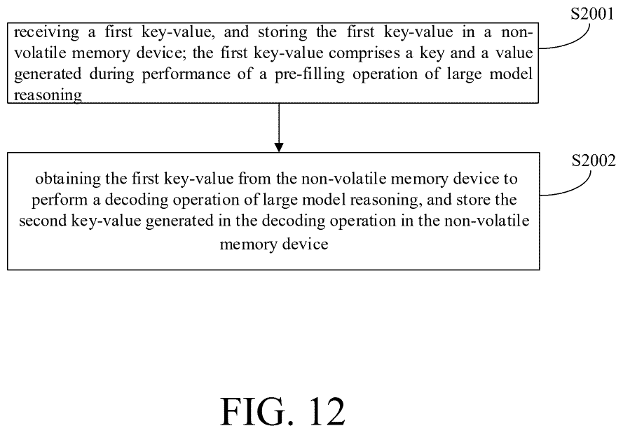

Based on the above system, an example of the present disclosure also provides a method of operating a memory system, as shown in FIG. 12, the method of operating the memory system comprises the following operations: operation S2001: receiving a first key-value, and storing the first key-value in a non-volatile memory device; the first key-value comprises a key and a value generated during performance of a pre-filling operation of large model reasoning; operation S2002: obtaining the first key-value from the non-volatile memory device to perform a decoding operation of large model reasoning, and store the second key-value generated in the decoding operation in the non-volatile memory device.

In some examples, the non-volatile memory device is configured to store the first key-value and the second key-value in a manner of storing one bit of data per memory cell.

In some examples, the non-volatile memory device comprises a three-dimensional NAND-type memory device.

In some examples, the decoding operation comprises a decoding attention operation and a decoding feedforward neural network operation; performing a decoding operation of large model reasoning, and storing a second key-value generated in the decoding operation in a non-volatile memory device, comprises: performing a decoding attention operation; storing the second key-value generated in the decoding attention operation in a non-volatile memory device.

In some examples, performing a decoding operation for large model reasoning comprises: performing a decoding feedforward neural network operation.

In some examples, the non-volatile memory device is configured to store a first weight required in a decoding attention operation and a second weight required in a decoding feedforward neural network operation.

In some examples, the decoding operation comprises a decoding attention operation and a decoding feedforward neural network operation; the operation method also comprises: obtaining a first weight required in the decoding attention operation; performing a decoding operation of large model reasoning, comprises: in the decoding attention operation, generating a projection output and a second key-value based on the first key-value and the first weight.

In some examples, the operation method also comprises: obtaining a second weight required in a decoding feedforward neural network operation; performing a decoding operation of large model reasoning, comprises: in the decoding feedforward neural network operation, generating a reasoning output result based on the second weight and the projection output.

The method of operating the memory system mentioned in the above example has been described in detail in the above example of the system, and will not be repeated here for the sake of brevity.

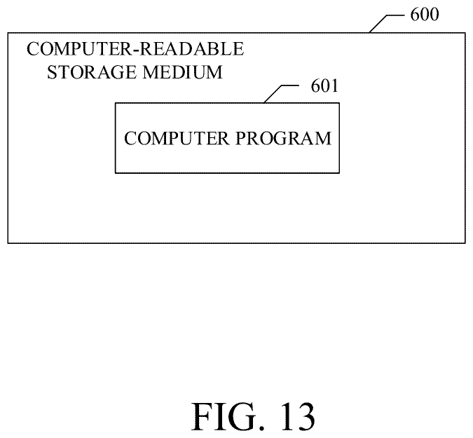

As shown in FIG. 13, an example of the present disclosure further provides a computer-readable storage medium 600 on which a computer program 601 is stored thereon. When the computer program 601 is executed by a processor, a method of operating a system as in any of the above examples and a method of operating a memory system as in any of the above examples may be executed.

Here, all or part of the processes in the method of operating the memory system in the above example and the method of operating the system may be implemented by a computer program instructing the relevant hardware, and the program may be stored in a computer-readable storage medium. When the program is executed, it may include the processes of the examples of the above methods. Among them, the storage medium may be a ferromagnetic random access memory (FRAM), a read-only memory (ROM), a programmable read-only memory (PROM), an erasable programmable read-only memory (EPROM), an electrically erasable programmable read-only memory (EEPROM), a flash memory, a magnetic surface memory, an optical disc or a compact disc read-only memory (CD-ROM), etc. ; the computer-readable storage medium may also include a combination of the above-mentioned types of memory.

The features disclosed in the several device examples provided in the present disclosure may be arbitrarily combined to obtain a new device example without conflict.

The methods disclosed in the several method examples provided in the present disclosure may be arbitrarily combined to obtain a new method example without conflict.

The above description is only a specific example of the present disclosure, but the protection scope of the present disclosure is not limited thereto. Any person skilled in the art can easily think of changes or substitutions within the technical scope disclosed in the present disclosure, which should be comprised in the protection scope of the present disclosure.

What is claimed is:

1. A system, comprising:
at least one processor configured to:
perform a pre-filling operation of large model reasoning; and
output a first key-value generated in the pre-filling operation;
a non-volatile memory device; and
a memory controller coupled to the non-volatile memory device and configured to:
store the first key-value in the non-volatile memory device; and
obtain the first key-value from the non-volatile memory device to perform a decoding operation of the large model reasoning, and store a second key-value generated in the decoding operation in the non-volatile memory device.

2. The system of claim 1, wherein the non-volatile memory device is configured to store the first key-value and the second key-value by storing one bit of data per memory cell.

3. The system of claim 1, wherein the non-volatile memory device comprises a three-dimensional NAND type memory device.

4. The system of claim 1, wherein the decoding operation comprises a decoding attention operation and a decoding feedforward neural network operation; and the memory controller is configured to:
perform the decoding attention operation; and
store the second key-value generated in the decoding attention operation in the non-volatile memory device.

5. The system of claim 4, wherein the memory controller is configured to: perform the decoding feedforward neural network operation.

6. The system of claim 1, wherein the at least one processor is configured to:
obtain a first query, a key in the first key-value, and a value in the first key-value based on each of tokens in a prompt in a user input.

7. The system of claim 4, wherein the non-volatile memory device is configured to store a first weight required in the decoding attention operation and a second weight required in the decoding feedforward neural network operation.

8. The system of claim 1, wherein the decoding operation comprises a decoding attention operation and a decoding feedforward neural network operation; and the memory controller is configured to:
obtain a first weight required in the decoding attention operation; and
in the decoding attention operation, generate a projection output and the second key-value based on the first key-value and the first weight.

9. The system of claim 8, wherein in the decoding attention operation, the memory controller is configured to:
generate a second query, a key in the second key-value, and a value in the second key-value based on the first weight and an input vector;
obtain an attention score based on a key in the first key-value, the key in the second key-value, and the second query;
obtain an attention weight based on the attention score;
obtain a weighted output based on the attention weight, the value in the first key-value, and the value in the second key-value; and
obtain a projection output based on the weighted output and the first weight.

10. The system of claim 8, wherein:
the memory controller is configured to:
obtain a second weight required in the decoding feedforward neural network operation; and
in the decoding feedforward neural network operation, generate a reasoning output result based on the second weight and the projection output; and
the at least one processor is configured to: receive the reasoning output result.

11. The system of claim 1, comprising:
a memory system comprising:
the non-volatile memory device,
the memory controller, and
a first interface circuit; and
a host coupled to the memory system and comprising:
the at least one processor, and
a second interface circuit,
wherein the memory controller interacts with the least one processor through the first interface circuit and the second interface circuit.

12. The system of claim 11, wherein the host further comprises a volatile memory device coupled to the at least one processor.

13. A memory system, comprising:
a non-volatile memory device; and
a memory controller coupled to the non-volatile memory device and configured to:
receive a first key-value and store the first key-value in the non-volatile memory device, wherein the first key-value comprises a key and a value generated during performance of a pre-filling operation of large model reasoning; and
obtain the first key-value from the non-volatile memory device to perform a decoding operation of the large model reasoning, and store a second key-value generated in the decoding operation in the non-volatile memory device.

14. The memory system of claim 13, wherein the non-volatile memory device is configured to store the first key-value and the second key-value in a manner of storing one bit of data per memory cell.

15. The memory system of claim 13, wherein the decoding operation comprises a decoding attention operation and a decoding feedforward neural network operation; and the memory controller is configured to:
perform the decoding attention operation; and
store the second key-value generated in the decoding attention operation in the non-volatile memory device.

16. The memory system of claim 15, wherein the memory controller is configured to:
perform the decoding feedforward neural network operation.

17. The memory system of claim 15, wherein the non-volatile memory device is configured to store a first weight required in the decoding attention operation and a second weight required in the decoding feedforward neural network operation.

18. The memory system of claim 13, wherein the decoding operation comprises a decoding attention operation and a decoding feedforward neural network operation; and the memory controller is configured to:
obtain a first weight required in the decoding attention operation; and
in the decoding attention operation, generate a projection output and the second key-value based on the first key-value and the first weight.

19. A method of operating a system, comprising:
by at least one processor, performing a pre-filling operation of large model reasoning and outputting a first key-value generated in the pre-filling operation;
by a memory controller, storing the first key-value in a non-volatile memory device coupled to the memory controller; and
by the memory controller, obtaining the first key-value from the non-volatile memory device to perform a decoding operation of the large model reasoning, and storing a second key-value generated in the decoding operation in the non-volatile memory device.

20. The method of claim 19, wherein the non-volatile memory device is configured to store the first key-value and the second key-value by storing one bit of data per memory cell.
